(19) United States
(12) Patent Application Publication
(10) Pub. No.: US 2008/0031795 A1
(43) Pub. Date: Feb. 7, 2008

(54) Method of Making Multiple Carbonaceous Nanomaterials

(75) Inventor: Steven A. Stevenson, Hattiesburg, MS (US)

Correspondence Address: BUCHANAN, INGERSOLL & ROONEY PC, POST OFFICE BOX 1404, ALEXANDRIA, VA, 22313-1404, US

(73) Assignee: LUNA INNOVATIONS INCORPORATED, Roanoke, VA (US)

(21) Appl. No.: 10/594,026

(22) PCT Filed: Mar. 25, 2005
(86) PCT No.: PCT/US05/10218

§ 371 Date: Jul. 23, 2007

Related U.S. Application Data
(60) Provisional application No. 60/556,503, filed on Mar. 26, 2004.

(51) Int. Cl. C01B 31/02

(52) U.S. Cl. 423/263; 423/447.1; 977/744; 977/742

(57) ABSTRACT

A method of making multiple carbonaceous nanomaterials is provided. Embodiments of the method can produce a reaction product that includes trimetaspheres, nanotubes, and at least one of fullerenes and metallofullerenes. A preferred embodiment of the method includes reacting at least one carbon source, nitrogen source, copper source, yttrium source, transition metal, and trimetasphere-forming metal in a reaction chamber. The reaction product can be produced by arc discharge in the presence of nitrogen gas.

### BACKGROUND

Fullerenes are a family of closed-caged molecules made up of carbon atoms arranged in a series of five and six-member carbon rings. Fullerene molecules can contain 500 or more carbon atoms, and typically contain less than 100 carbon atoms. Exemplary fullerene molecules include C₆₀, C₇₀, C₇₆, C₇₈ and C₈₄.

Since fullerenes were first synthesized, other molecules, such as C₆₀⁻ and C₆₀²⁻ anions, fullerene molecules with various substituents added, and molecules including metal atoms trapped inside the carbon cages have also been synthesized.

### SUMMARY

A method of making multiple fullerene structures is provided. The fullerene structures can be traditional fullerene structures, e.g., one or more of C₆₀, C₇₀, C₇₆, C₇₈ and C₈₄; metallofullerenes; trimetaspheres and nanotubes. Derivatives of traditional fullerenes also can be prepared that include various selected metals (and also nitrogen) encapsulated inside the carbon cage.

A preferred embodiment of a method of making multiple carbonaceous nanomaterials is provided, which comprises introducing into a reaction chamber at least one carbon source, nitrogen source, copper source, yttrium source, transition metal, and trimetasphere-forming metal. The at least one carbon source, nitrogen source, copper source, yttrium source, transition metal, and trimetasphere-forming metal are reacted in the reaction chamber under conditions effective to produce a reaction product comprising trimetaspheres, nanotubes, and at least one of (i) fullerenes and (ii) metallofullerenes. Accordingly, the preferred embodiment can produce two, three or all four of the major types of fullerene structures in a single production run.

In a preferred embodiment, the carbon source is a carbonaceous material in which other starting material components are placed. For example, the carbonaceous material can be graphite. The nitrogen source is preferably a nitrogen-containing gas, which is supplied into the reaction chamber during the reaction.

A preferred embodiment of a reaction product also is provided, which comprises trimetaspheres, nanotubes, and at least one of (i) fullerenes and (ii) metallofullerenes. Accordingly, the reaction product can comprise two, three or all four of the major types of fullerene structures.

A preferred embodiment of a method of making trimetaspheres is provided, which comprises introducing at least one metal, carbon, nitrogen and copper into a reaction chamber; and reacting the metal, carbon, nitrogen and copper to produce trimetaspheres.

A preferred embodiment of a method of making carbon nanotubes is provided, which comprises reacting at least a transition metal, yttrium source and carbon in the presence of a nitrogen-containing gas and helium.

### BRIEF DESCRIPTION OF THE DRAWING FIGURES

FIG. 1 is an HPLC trace for reaction product produced in Example 1, showing peaks indicating the presence of C₆₀ and Y₃N@C₈₀.

FIG. 2 is a mass spectroscopy (MS) trace for reaction product produced in Example 1, showing peaks indicating the presence of C₆₀ and C₇₀.

FIG. 3 is an HPLC trace for reaction product produced in Example 2, showing peaks indicating the presence of C₆₀, C₇₀ and Y₃N@C₈₀.

FIG. 4 is an MS trace for reaction product produced in Example 2, showing peaks indicating the presence of C₆₀, C₇₀ and Y₃N@C₈₀.

FIG. 5 is an HPLC trace for reaction product produced in Example 3, showing peaks indicating the presence of C₆₀, C₇₀ and Y₃N@C₈₀.

FIG. 6 is an MS trace for reaction product produced in Example 3, showing peaks indicating the presence of C₆₀, C₇₀ and Y₃N@C₈₀.

FIG. 7 is an SEM micrograph of reaction product produced in Example 3, showing the presence of nanotubes.

### DETAILED DESCRIPTION

Four major types, i.e., structures, of carbonaceous nanomaterials are traditional fullerene molecules, which are referred to herein as “fullerenes”; one or more metals (without nitrogen) entrapped within carbon cages, which are referred to herein as metallofullerenes; trimetallic nitride nanoclusters entrapped within carbon cages, which are referred to herein as “trimetaspheres”; and nanotubes.

The metallofullerenes are produced by modifying fullerene molecules to include one or more metals that are trapped inside the carbon cage. Exemplary metallofullerenes include Sc₂@C₈₄, Er₂@C₈₂ and Gd@C₈₂. Accepted symbols for elements and for subscripts to denote numbers of elements are used herein. Further, all elements to the right of an @ symbol are part of the fullerene cage network, while all elements listed to the left of the @ symbol are contained within the fullerene cage network.

The trimetaspheres are modified fullerenes that include at least one additional metal and nitrogen, which form trimetallic nitride nanoclusters trapped inside the carbon cage. The trimetaspheres have the general formula A₃₋ₙXₙN@Cₘ, where n=0, 1, 2 or 3; A is a first metal; X is a second, trivalent metal, and m is an even integer from about 60 to about 200. Typically, m is about 68, 78, or 80. Further, X can be a trivalent metal and can have an ionic radius below about 0.095 nm, and A can also be a trivalent metal and can have an ionic radius below about 0.095 nm.

For the trimetaspheres, the metal A can be an element selected from the rare earth elements and the group IIIB elements. For example, A may be Sc, Y, La, Gd, Ho, Er, Tm and Yb. The metal X can also be an element selected from the rare earth elements and group IIIB elements. For example, metal X may be Sc, Y, La, Gd, Ho, Er, Tm and Yb. Exemplary trimetaspheres include Y₃N@C₈₀, Sc₃N@C₈₀, Er₃N@C₈₀, Lu₃N@C₈₀, ErSc₂N@C₈₀ and LaₙSc₃₋ₙN@C₈₀. Exemplary trimetaspheres that can be produced by embodiments of the method disclosed herein are disclosed in U.S. Pat. No. 6,303,760, which is hereby incorporated by reference in its entirety.

Nanotubes are long, cylindrical structures composed of carbon atoms arranged in a mesh pattern. Nanotubes can include, for example, single-wall and muti-wall nanotubes, which consist of several concentric cylinders.

It has unexpectedly been determined that preferred embodiments of the method of making multiple fullerene structures can make two, three or all four of the major types of fullerene structures in a single production run, i.e., in a single batch. The fullerene structures can be traditional fullerene structures, e.g., one or more of C₆₀, C₇₀, C₇₆, C₇₈ and C₈₄; metallofullerenes; trimetaspheres and nanotubes. Derivatives of traditional fullerenes can be prepared that include various selected metals (and also nitrogen) encapsulated inside the carbon cage.

A preferred embodiment of the method of making multiple fullerene structures is provided, which can make at least trimetaspheres and nanotubes. Another preferred embodiment of the method of making multiple fullerene structures is provided, which can make trimetaspheres, nanotubes, and at least one of fullerenes and metallofullerenes. Yet another preferred embodiment of the method of making multiple fullerene structures is provided, which can make each of trimetapheres, nanotubes, fullerenes, and metallofullerenes.

Multiple fullerene structures can be made by selecting an appropriate starting material. Particularly, the starting material can include at least one carbon source, at least one nitrogen source, at least one copper source, at least one transition metal, and at least one trimetasphere-forming metal. The relative amounts of the starting material components can be selected to provide a reaction product containing desired fullerene structures. The carbon source produces the carbon network of all four major fullerene structures. The carbon source can be, for example, graphite. The nitrogen source is preferably N₂ gas. Alternatively, the nitrogen source can be in solid form, such as a carbon nitride or a metal nitride where the metal to be encapsulated is in nitride form. It has unexpectedly been determined that the copper source promotes trimetasphere yield. The copper source can be, for example, one or more of Cu, CuO, Cu₃P, CuS, Cu₂S and the like. The transition metal source, such as Ni and/or Fe, acts as a catalyst for nanotube formation. The yttrium source acts to promote nanotube growth, and can be, for example, one or more of Y, Y₂O₃ and YN. As explained above, the trimetasphere-forming metal can be selected from the elements of Group IIIB of the periodic table and the rare-earth metals. Accordingly, yttrium can be added to both promote nanotube growth and trimetasphere formation.

In a preferred embodiment of the method of making multiple fullerene structures, a suitable combination of materials is placed within a carbonaceous material and subjected to processing under suitable conditions. The carbonaceous material can be a source of carbon to produce the carbon network of all four major fullerene structures. The material placed within the carbonaceous material can be one or more metals, or one or more metals plus a solid nitrogen source (for making trimetaspheres).

The carbonaceous material is preferably graphite. Graphite can be provided in the form of a container, which is used to contain other components. For example, graphite can be in the form of a cored graphite rod or have any other suitable configuration. The graphite rod can have any suitable dimensions, such as a diameter of from ¼ in to about ½ in and a length of from about 6 in to about 12 in. Fullerene structure-forming components can be encapsulated by packing the cored graphite rod with a selected amount of the starting material for making the desired fullerene structures.

According to a preferred embodiment of the method of making multiple fullerene structures, the carbonaceous material (e.g., a graphite rod) packed with a suitable fullerene-structure forming material, preferably in powder form, is placed in a chamber of a heated vessel. The chamber, such as a furnace chamber, is heated under conditions effective to cause some cementing or “curing” of the packed material so that it can hold together during the subsequent “burning” step. The furnace can be, for example, a tube furnace. The furnace temperature is preferably from about 700° C. to about 1100° C, to achieve curing. The packed carbonaceous material is preferably heated in the furnace for about 1 hour to about 24 hours. During heating, a suitable gas is supplied into the furnace. The gas can be, for example, N₂, Ar, He, Ne or the like. The flow rate of the gas is preferably sufficiently high to prevent exposure of the packed carbonaceous with oxygen.

After the packed graphite rod or the like has been heated in the furnace, it is preferably allowed to cool, and then placed in a reaction chamber to perform the “burning” step. The reaction chamber can be, for example, a Kratschmer-Huffman generator. This type of generator typically has a reaction chamber that can be evacuated and charged with a controlled pressure of an inert gas, such as helium or the like. The generator includes two electrodes within the reaction chamber and is operable to apply a potential across the electrodes to produce an arc discharge. The packed graphite rod can be used in the generator as either the anode or cathode. A potential is applied across the electrodes to produce an arc discharge. The arc discharge vaporizes the material in the rod, as well as a portion of the rod. The vapor cools and condenses on a cool surface in the reaction chamber, thereby producing a reaction product that contains carbon products and which is referred to herein as “soot.” Depending on the starting material used, the soot can contain trimetaspheres, nanotubes, and optionally also at least one of fullerenes, and metallofullerenes.

In a preferred embodiment, the nitrogen source is a nitrogen-containing gas, preferably N₂, which is supplied into the generator during the burning step. In addition to N₂, helium is preferably also flowed into the generator during the burning step. It has unexpectedly been determined that carbon nanotubes can be produced in the helium atmosphere also containing nitrogen gas. Although other inert gases, such as argon, may be used instead of helium, it has been determined that such gases may not provide as high of a yield of the fullerene structures as helium. The flow rate of helium can be, for example, about 800 ml/min to about 1200 ml/min, and the flow rate of N₂ can be, for example, about 80 ml/min to about 120 ml/min. The gas flow rate is preferably sufficient to maintain a pressure of about 800 torr to about 1000 torr, more preferably about 900 torr, in the reaction chamber during burning. It has been determined that increasing the ratio of the flow rate of N₂ to the flow rate of helium (i.e., N₂/helium) can decrease the yield of fullerene structures and may, if this ratio is too high, result in trimetaspheres not forming. The burn time can typically vary from about 20 minutes to about 60 minutes. The applied voltage and current can be selected to produce suitable vaporization conditions.

Traditional fullerenes, metallofullerenes, and trimetaspheres can be separated from the remainder of the soot produced in the reaction chamber. These reaction products can be separated, for example, by a solvent extraction technique using any suitable solvent that is effective to dissolve the fullerenes, metallofullerenes and trimetaspheres. Xylene is an exemplary suitable solvent for this purpose. The solvent can be provided in a solvent tower. The fullerenes, metallofullerenes and trimetaspheres in the extract can be further separated by any suitable technique, including high-performance liquid chromatography (HPLC), chemical separation, or thermal separation.

It has been determined that carbon nanotubes are not soluble in xylene and remain in the soot following the solvent extraction of the fullerenes, metallofullerenes and trimetaspheres. The depleted soot containing carbon nanotubes can be subjected to purification to separate residual metal catalyst materials, fullerene anion-type materials, and amorphous carbon. It is contemplated that the soot may be subjected to an acid treatment to remove metal impurities and an optional thermal treatment coupled with a chemically reactive thermal environment to further purify the nanotube-containing material.

Exemplary embodiments of the method for making multiple carbonaceous nanomaterials are illustrated in the following examples. The examples are provided for illustration purposes and should not be construed as limiting the scope of the method.

### EXAMPLE 1

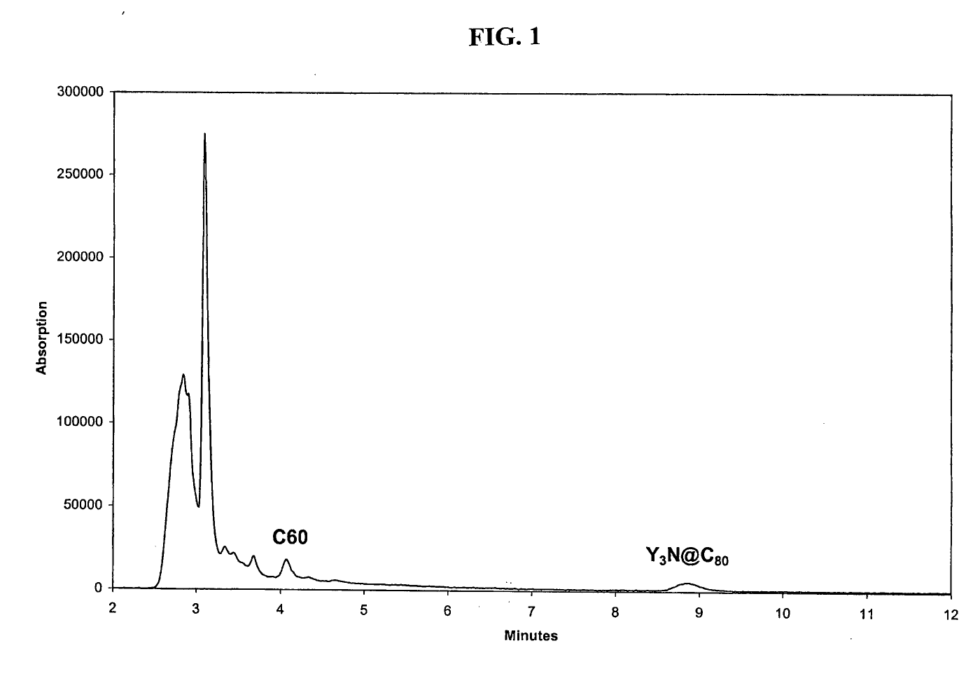

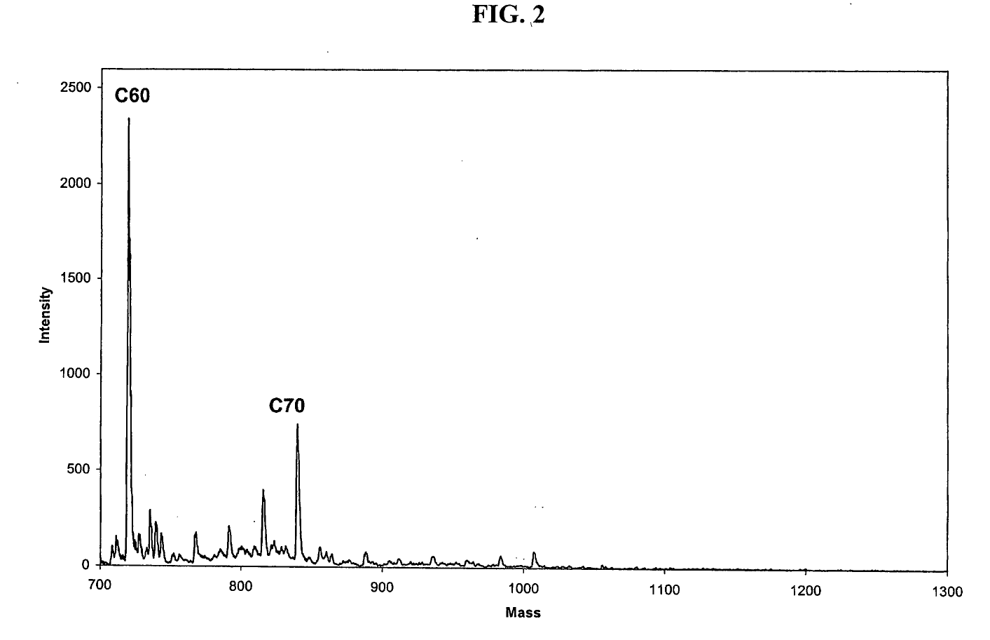

A cored graphite rod having a length of about 6 in and a diameter of about ¼ inch was packed with a mixture of Ni powder, Y powder and Cu powder in a weight ratio (grams) of about 0.7/0.55/0.55. The packed graphite rod was placed in a tube furnace at a temperature of about 1025° C. for about 4 hours under a N₂ gas flow. The graphite rod was subsequently mounted as an electrode in a reaction chamber of a Kratschmer-Huffman generator. A voltage of about 31 volts and a current of about 65 amperes were applied and the packed graphite rod was burned (vaporized) for about 26 min in a He/N₂ atmosphere. The atmosphere had a pressure of about 900 torr and was obtained by flowing helium at a flow rate of about 900 ml/min and N₂ at a flow rate of about 80 ml/min into the reaction chamber. The test results for Example 1 are shown in the Table below. The soot formed in the reaction chamber was removed and subjected to solvent extraction. FIG. 1 is an HPLC trace for reaction product (soot) produced in Example 1, showing peaks indicating the presence of C₆₀ and Y₃N@C₈₀. FIG. 2 is a mass spectroscopy (MS) trace for reaction product produced in Example 1, showing peaks indicating the presence of C₆₀ and C₇₀.

### EXAMPLE 2

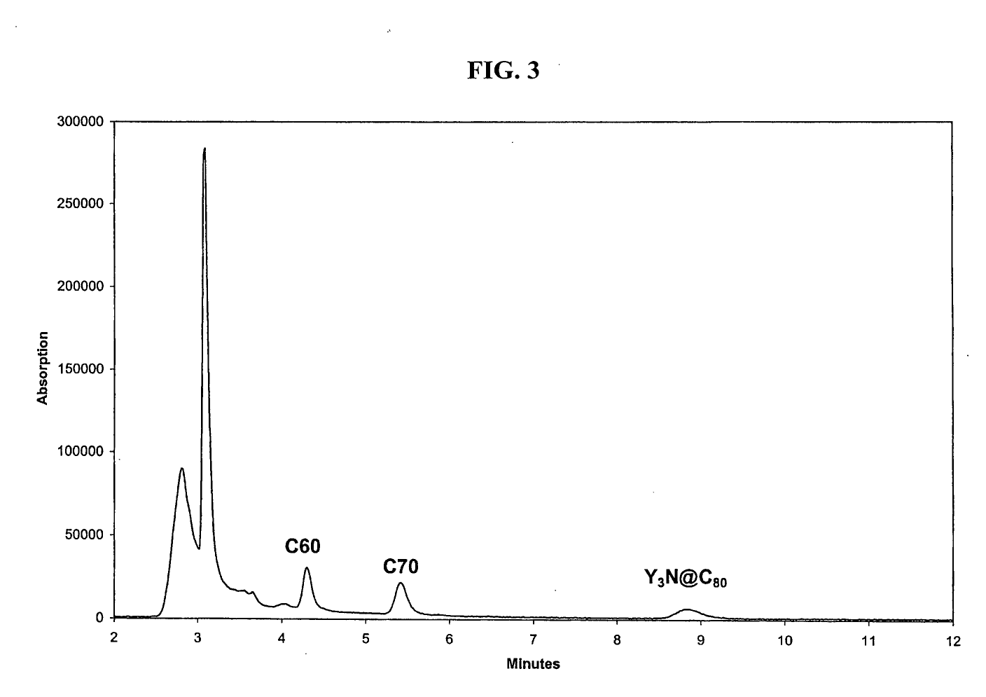

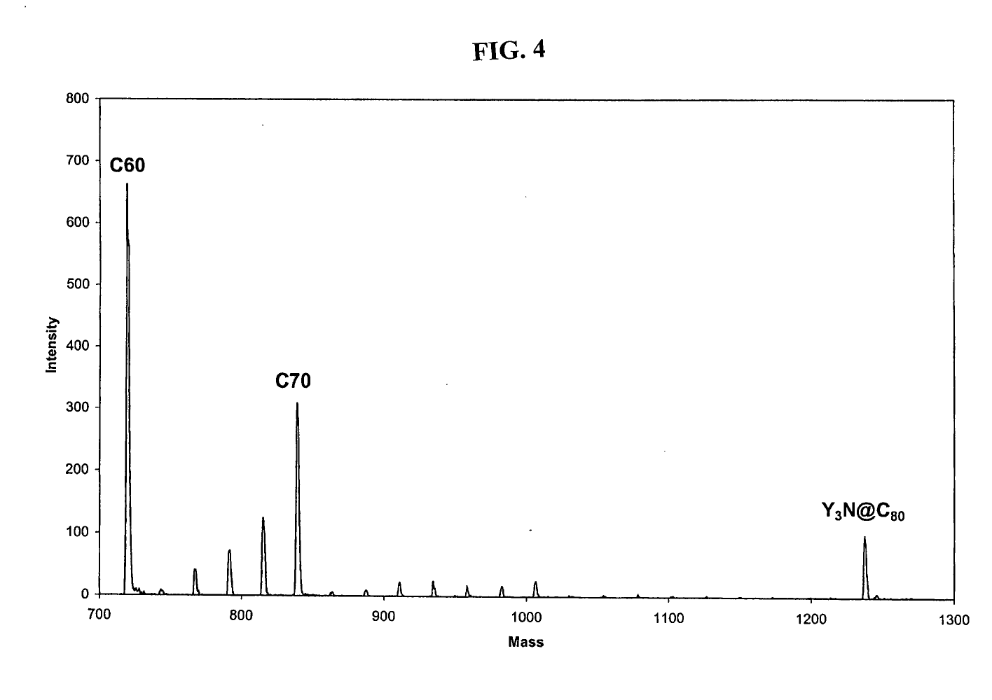

A cored graphite rod having a length of about 6 inch and a diameter of about ¼ inch was packed with a mixture of Ni powder, Y powder and Cu powder in a weight ratio (grams) of about 0.7/1.65/0.55. The packed graphite rod was placed in a tube furnace at a temperature of about 1025° C. for about 4 hours under a N₂ gas flow. The graphite rod was subsequently mounted as an electrode in a reaction chamber of a Kratschmer-Huffman generator. A voltage of about 31 volts and a current of about 65 amperes were applied and the packed graphite rod was burned for about 26 min in a He/N₂ atmosphere. The atmosphere had a pressure of about 900 torr and was obtained by flowing helium at a flow rate of about 900 ml/min and N₂ at a flow rate of about 80 ml/min into the reaction chamber. The test results for Example 2 are shown in the Table. Also, FIG. 3 is an HPLC trace for reaction product produced in Example 2, showing peaks indicating the presence of C₆₀, C₇₀ and Y₃N@C₈₀. FIG. 4 is an MS trace for reaction product produced in Example 2, showing peaks indicating the presence of C₆₀, C₇₀ and Y₃N@C₈₀.

### EXAMPLE 3

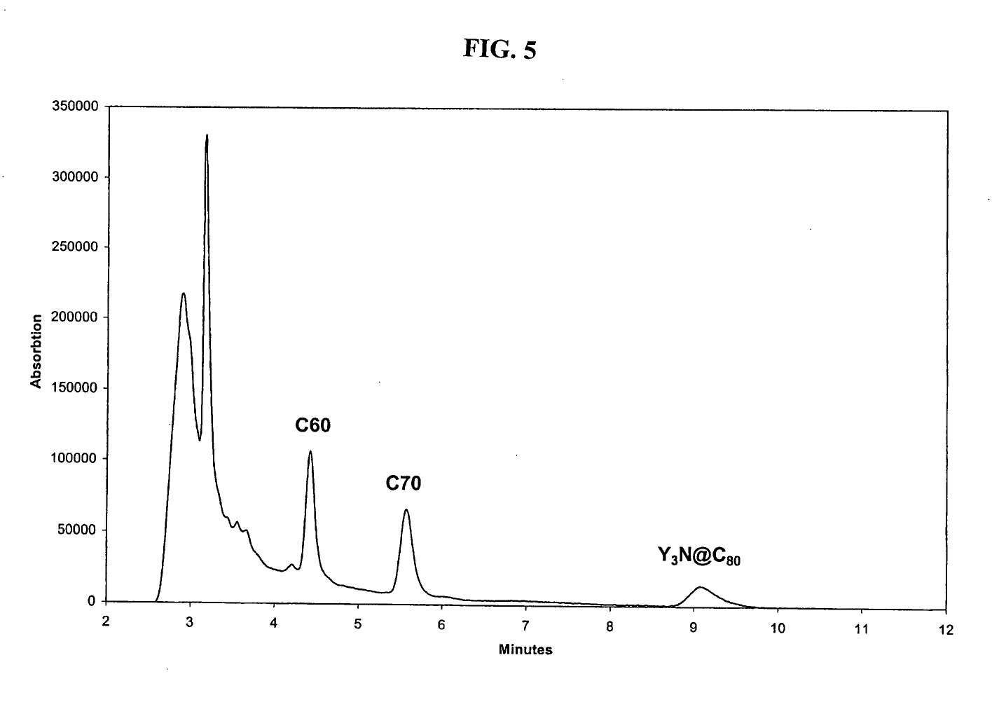

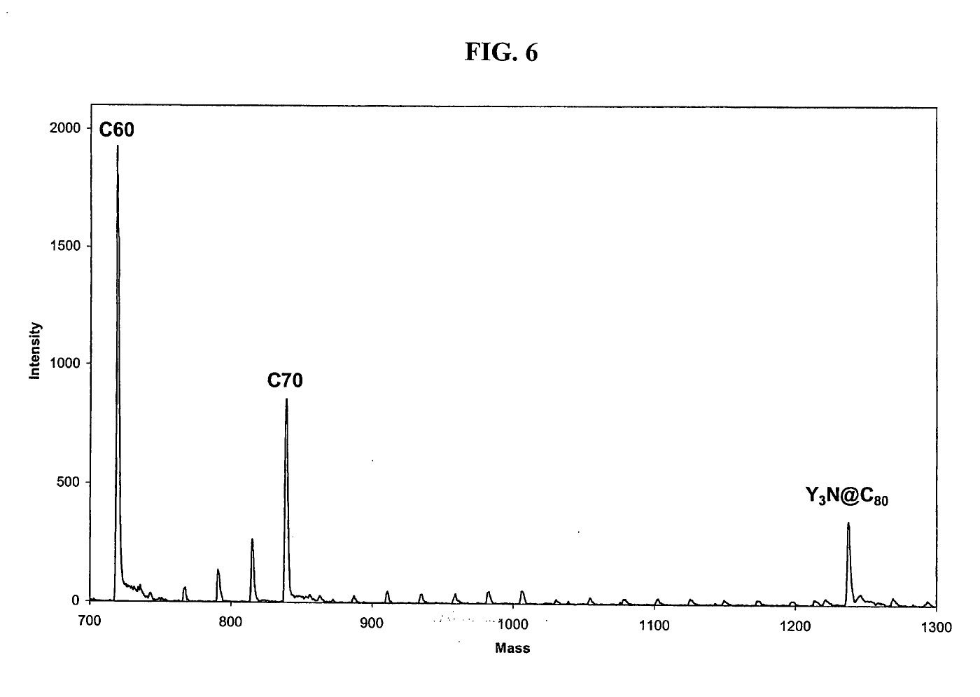

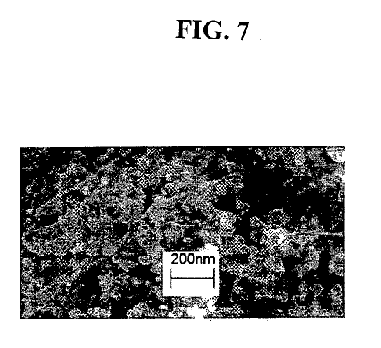

A cored graphite rod having a length of about 6 inch and a diameter of about ¼ inch was packed with a mixture of C powder, Ni powder, Y powder and Cu powder in a weight ratio (grams) of about 1.0/0.7/1.65/0.55. The packed graphite rod was placed in a tube furnace at a temperature of about 1025° C. for about 4 hours under a N₂ gas flow. The graphite rod was subsequently mounted as an electrode in a reaction chamber of a Kratschmer-Huffman generator. A voltage of about 31 volts and a current of about 65 amperes were applied and the packed graphite rod was burned for about 26 min in a He/N₂ atmosphere. The atmosphere had a pressure of about 900 torr and was obtained by flowing helium at a flow rate of about 900 ml/min and N₂ at a flow rate of about 80 ml/min into the reaction chamber. The test results for Example 3 are shown in the Table. The extract was analyzed using HPLC. FIG. 5 is an HPLC trace for reaction product produced in Example 3, showing peaks indicating the presence of C₆₀, C₇₀ and Y₃N@C₈₀. FIG. 6 is an MS trace for reaction product produced in Example 3, showing peaks indicating the presence of C₆₀, C₇₀ and Y₃N@C₈₀. A portion of the soot that was not dissolved by solvent extraction was analyzed by scanning electron microscopy (SEM). As shown in the FIG. 7, the soot contained nanotubes.

TABLE

| | | | | | | Mass of | | | |
|---|---|---|---|---|---|---|---|---|---|
| | | | | | | Packed | | | |
| | | | | | Mass | Rod | Mass of | Mass | Length |
| | | | | | of | Before | Rod After | of Rod | of Rod |
| | | Mass Ratio of | Burn | Soot | Empty | Furnace | Furnace | After | After |
| Sample | | Components of | Time | Weight | Rod | Treatment | Treatment | Burning | Burning |
| No. | Material | Material | (min) | (g) | (g) | (g) | (g) | (g) | (in) |
| 1 | Ni/Y/Cu | 0.7/0.55/0.55 | 26 | 6.64 | 5.24 | 10.62 | 10.43 | 2.34 | 2 |
| 2 | Ni/Y/Cu | 0.7/1.65/0.55 | 28 | 4.49 | 5.23 | 9.50 | 9.42 | 2.06 | 1 12/16 |
| 3 | C/Ni/Y/Cu | 1.0/0.7/1.65/0.55 | 32 | 4.87 | 5.21 | 8.04 | 8.05 | 2.20 | 1 13/16 |

The present invention has been described with reference to preferred embodiments. However, it will be readily apparent to those skilled in the art that it is possible to embody the invention in specific forms other than as described above without departing from the spirit of the invention. The preferred embodiments are illustrative and should not be considered restrictive in any way. The scope of the invention is given by the appended claims, rather than the preceding description, and all variations and equivalents that fall within the range of the claims are intended to be embraced therein.

What is claimed is:

1. A method of making multiple carbonaceous nanomaterials, comprising:
introducing at least one carbon source, at least one nitrogen source, at least one copper source, at least one yttrium source, at least one transition metal, and at least one trimetasphere-forming metal into a reaction chamber; and
reacting the at least one carbon source, nitrogen source, copper source, yttrium source, transition metal, and trimetasphere-forming metal under conditions effective to produce a reaction product comprising trimetaspheres, nanotubes, and at least one of (i) fullerenes and (ii) metallofullerenes.

2. The method of claim 1, wherein the reaction product comprises trimetaspheres, nanotubes, fullerenes, and metallofullerenes.

3. The method of claim 1, wherein the carbon source is graphite.

4. The method of claim 3, wherein the graphite is graphite powder.

5. The method of claim 3, wherein the at least one carbon source is a container composed of graphite, and the at least one nitrogen source, copper source, yttrium source, transition metal, trimetasphere-forming metal and optionally carbon are placed inside the container which is placed in the reaction chamber.

6. The method of claim 5, wherein the container is a cored graphite rod.

7. The method of claim 1, wherein the at least one nitrogen source is N₂ gas.

8. The method of claim 7, wherein the N₂ gas and helium are supplied into the reaction chamber.

9. The method of claim 8, wherein the helium is supplied into the reaction chamber at a flow rate of about 800 ml/min to about 1200 ml/min, the N₂ is supplied into the reaction chamber at a flow rate of about 80 ml/min to about 120 ml/min, and gas pressure within the reaction chamber is about 800 torr to about 1000 torr.

10. The method of claim 1, wherein the at least one nitrogen source is at least one nitride material.

11. The method of claim 1, wherein the at least one copper source is Cu and/or at least one copper-containing compound.

12. The method of claim 1, wherein the at least one transition metal is effective to catalyze the formation of the nanotubes.

13. The method of claim 12, wherein the transition metal is Ni and/or Fe.

14. The method of claim 1, wherein the at least one yttrium source is Y and/or at least one yttrium-containing compound.

15. The method of claim 1, wherein the trimetasphere-forming metal is selected from the elements of Group IIIB of the periodic table and the rare-earth metals.

16. The method of claim 1, wherein the at least one trimetasphere-forming metal is yttrium.

17. The method of claim 1, further comprising, prior to the introducing, heating the at least one carbon source, nitrogen source, copper source, yttrium source, transition metal and trimetasphere-forming metal in a vessel at a temperature of about 700° C. to about 1100° C. and for a period of about 1 hour to about 24 hours.

18. The method of claim 1, wherein the at least one transition metal is Ni, the at least one trimetasphere-forming metal is Y, the at least one copper source is Cu, and the at least one nitrogen source is N₂.

19. The method of claim 18, wherein the Ni, Y and Cu have a respective weight ratio of about 0.7/0.55/0.55.

20. The method of claim 18, wherein the Ni, Y and Cu have a respective weight ratio of about 0.7/1.65/0.55.

21. The method of claim 18, wherein the carbon source comprises carbon, and the carbon, Ni, Y and Cu have a respective weight ratio of about 1.0/0.7/0.55/0.55.

22. The method of claim 18, wherein the carbon source comprises carbon, and the carbon, Ni, Y and Cu have a respective weight ratio of about 1.0/0.7/1.65/0.55.

23. The method of claim 1, wherein the reaction chamber is in an electric-arc discharge generator.

24. The method of claim 1, further comprising, prior to the supplying, determining relative masses of at least the at least one copper source, yttrium source, transition metal, and trimetasphere-forming metal effective to produce a selected reaction product.

25. A reaction product produced by the method according to claim 1.

26. The reaction product of claim 25, which comprises trimetaspheres, nanotubes, fullerenes, and metallofullerenes.

27. A method of making multiple carbonaceous nanomaterials, comprising:
introducing into a reaction chamber at least one copper source, at least one yttrium source, at least one transition metal, and at least one trimetasphere-forming metal in a carbonaceous material; and
vaporizing the at least one copper source, yttrium source, transition metal, trimetasphere-forming metal and carbonaceous material in the presence of nitrogen and producing a reaction product comprising trimetaspheres, nanotubes, and at least one of (i) fullerenes and (ii) metallofullerenes.

28. The method of claim 27, wherein the reaction product comprises trimetaspheres, nanotubes, fullerenes, and metallofullerenes.

29. The method of claim 27, wherein the carbonaceous material is graphite.

30. The method of claim 27, further comprising placing a carbon source in the carbonaceous material.

31. The method of claim 27, wherein the carbonaceous material is a cored graphite rod.

32. The method of claim 27, wherein the nitrogen is N₂ gas.

33. The method of claim 32, wherein the N₂ gas and helium are supplied into the reaction chamber.

34. The method of claim 33, wherein the helium is supplied into the reaction chamber at a flow rate of about 800 ml/min to about 1200 ml/min, the N₂ is supplied into the reaction chamber at a flow rate of about 80 ml/min to about 120 ml/min, and gas pressure within the reaction chamber is about 800 torr to about 1000 torr.

35. The method of claim 27, wherein the nitrogen is at least one nitride material which is placed in the carbonaceous material.

36. The method of claim 27, wherein the at least one copper source is Cu and/or at least one copper-containing compound.

37. The method of claim 27, wherein the at least one transition metal is effective to catalyze the formation of the nanotubes.

38. The method of claim 37, wherein the at least one transition metal is Ni and/or Fe.

39. The method of claim 27, wherein the at least one yttrium source is Y and/or at least one yttrium-containing compound.

40. The method of claim 27, wherein the at least one trimetasphere-forming metal is selected from the elements of Group IIIB of the periodic table and the rare-earth metals.

41. The method of claim 40, wherein the at least one trimetasphere-forming metal is Y.

42. The method of claim 27, further comprising, prior to the introducing, heating the at least one copper source, yttrium source, transition metal and trimetasphere-forming metal in a vessel at a temperature of about 700° C. to about 1100° C. and for a period of about 1 hour to about 24 hours.

43. The method of claim 27, wherein the at least one transition metal is Ni, the at least one trimetasphere-forming metal is Y, the at least one copper source is Cu, and the nitrogen is N₂.

44. The method of claim 43, wherein the Ni, Y and Cu have a respective weight ratio of about 0.7/0.55/0.55.

45. The method of claim 43, wherein the Ni, Y and Cu have a respective weight ratio of about 0.7/1.65/0.55.

46. The method of claim 43, further comprising introducing carbon in the carbonaceous material, the carbon, Ni, Y and Cu having a respective weight ratio of about 1.0/0.7/0.55/0.55.

47. The method of claim 43, further comprising introducing carbon in the carbonaceous material, the carbon, Ni, Y and Cu having a respective weight ratio of about 1.0/0.7/1.65/0.55.

48. The method of claim 27, wherein the reaction chamber is in an electric-arc discharge generator and the reacting comprises vaporizing the carbonaceous material and the at least one copper source, yttrium source, transition metal, and trimetasphere-forming metal.

49. A reaction product produced by the method according to claim 27.

50. The reaction product of claim 49, which comprises trimetaspheres, nanotubes, fullerenes and metallofullerenes.

51. A method of making multiple carbonaceous nanomaterials, comprising:
introducing a carbonaceous material and a powder mixture of at least one copper source, at least one yttrium source, at least one transition metal, and at least one trimetasphere-forming metal into a reaction chamber; and
reacting the carbonaceous material and powder mixture in the presence of a gas mixture of nitrogen and helium to produce a reaction product comprising trimetaspheres, nanotubes, and at least one of (i) fullerenes and (ii) metallofullerenes.

52. The method of claim 51, wherein the reacting comprises vaporizing the carbonaceous material and powder mixture, the vapor condensing.

53. The method of claim 51, wherein the reaction product comprises trimetaspheres, nanotubes, fullerenes and metallofullerenes.

54. A method of making trimetaspheres, comprising:
introducing at least one metal, carbon, nitrogen and copper into a reaction chamber; and
reacting the at least one metal, a carbon, nitrogen and copper to produce trimetaspheres.

55. The method of claim 54, wherein the at least one metal is selected from the group consisting of elements of group IIIB of the periodic table and rare earth metals.

56. The method of claim 54, wherein the nitrogen is a nitrogen-containing gas.

57. A reaction product comprising trimetaspheres, nanotubes, and at least one of (i) fullerenes and (ii) metallofullerenes.

58. The reaction product of claim 57, comprising trimetaspheres, nanotubes, fullerenes and metallofullerenes.

59. The reaction product of claim 57, which is soot formed by an arc discharge technique.

60. A method of making carbon nanotubes, comprising reacting at least a transition metal, yttrium source and carbon in the presence of a nitrogen-containing gas and helium.
